(19) United States
(12) Patent Application Publication
(10) Pub. No.: US 2013/0060528 A1
(43) Pub. Date: Mar. 7, 2013

(54) SYSTEM AND METHOD FOR DETERMINING A QUANTITY OF BULK MATERIAL

(71) Applicant: James Portman, Johannesburg (ZA)

(72) Inventor: James Portman, Johannesburg (ZA)

(21) Appl. No.: 13/474,877

(22) Filed: May 18, 2012

(30) Foreign Application Priority Data
May 20, 2011 (ZA) 2011/03725

(51) Int. Cl. G06M 1/00

(52) U.S. Cl. 702/191

(57) ABSTRACT

The quantity of bulk material in a pile of bulk material is determined using one or more laser scanners that scan the surface of the pile. The signal generated by the scanner(s) is transmitted to a remote computation system that uses the received signals to calculate the quantity of material in the pile. The calculated quantity can be expressed as a volume, a mass or a financial value. The calculated quantity can be sent to an end user either automatically or upon receipt of a request from the end user. The remote computation system can receive and process scanning signals from scanners that mounted to scan the surfaces of different piles of bulk material. The system can also include a server local to the scanners.

### CROSS REFERENCE TO RELATED APPLICATION

This application claims the priority of South African provisional patent application Ser. No. 2011/03725 filed on May 20, 2011, entitled “A System Of Determining A Quantity Of Bulk Material And A Method Thereof” the contents of which are relied upon and incorporated herein by reference in their entirety, and the benefit of priority under 35 U.S.C. 119(a) is hereby claimed.

### FIELD OF THE INVENTION

This invention relates to a system of determining a quantity of bulk material and a method thereof, and in particular, to provide traceable measured data.

### DESCRIPTION OF THE PRIOR ART

There are several conventional techniques for measuring bulk solid or granular materials stored in vessels such as silos or in storage bunkers or on stock piles. One of the existing techniques includes the step of combining measured data received from a number of sensors configured to sense the level of material and to take an average of the measured data to provide an estimate of the volume of the materials. A problem acknowledged by this technique is that there is a practical limitation on the number of measuring instruments or sensors that can be installed within and/or around a silo. This practical limitation reduces the accuracy of the measurements and, hence the accuracy of the estimated volume.

Another conventional technique includes the use of a stand-alone measuring device that can estimate volumes of materials. In this technique where, for example, the stand-alone instrument is an ultrasonic instrument which uses sound from a phased array transducer, the measuring angle is limited because of the indirectly proportional ratio of wavelength to sensor size. In order to obtain an acceptable resolution of an image of the materials, an extremely large transducer is required which becomes prohibitively expensive.

Furthermore, in the abovementioned techniques, walls of an enclosure containing the material need to be modeled and removed from the results. This is a complex exercise and the measured data tend to be unreliable because of the changing surface profile of the material. Furthermore, in the case where an audit of the measured data is required, the abovementioned techniques are unable to provide traceable measured data in order to support the measured data, in particular, the measured volume.

Currently, the most accurate technique is a laser-based technique. The technique produces a high resolution surface image of a pile of bulk material and a volume of the material is calculated from the produced image. The implementation of this technique is not easy and it requires specialized skills and portable instruments which incorporate both a laser scanning device and a processor for processing data generated by the scanning device and the results are expensive. In order to determine the quantity of material in a pile one or more of the instruments are transported to the site of the pile and positioned to scan the surface of the pile. In many instances, it is usually difficult to produce the entire image of the surface of the material because there is no suitable view point of placing the instrument. It is also risky and hazardous in order to try to find a suitable view point.

### SUMMARY OF THE INVENTION

A method of determining a quantity of bulk material in at least one pile of bulk material includes bit is not limited to:

scanning the surface of the pile of bulk material using one or more laser scanners;

generating a signal in response to the scanned surface;

transmitting the signal to a remote processor;

filtering the transmitted signal to remove therefrom any data that will interfere with the determination of the quantity of bulk material in the pile; and

calculating from the filtered transmitted signal the quantity of material in the pile.

A system for determining a quantity of bulk material in at least one pile of bulk material includes but is not limited to:

at least one laser scanner mountable or mounted such that there is a clear line of sight between the at least one laser scanner and a surface of the at least one pile of bulk material, the laser scanner being configured to generate a signal corresponding to the scanned surface;

a remote computation system; and

a communication arrangement whereby the at least one laser scanner is connectable in communication with the computation system, the computation system being configured to:

receive from the at least one laser scanner by way of the communication arrangement the signal generated by the at least one laser scanner; and

process the received signal to first remove therefrom any data that will interfere with the determination of the quantity of bulk material in the pile of material and then determine from the filtered received signal the quantity of bulk material in the pile of material and generate an output signal corresponding thereto.

A system for determining a quantity of bulk material in two or more piles of bulk material includes but is not limited to:

at least one laser scanner associated with a respective one of each of the two or more piles of bulk material, each of the laser scanners mountable or mounted such that there is a clear line of sight between each of the at least one laser scanners and a surface of the associated one of the two or more piles of bulk material, each of the laser scanners being configured to generate a signal corresponding to the scanned surface of each of the associated one of the two or more piles of bulk material;

a remote computation system comprising a filter; and

a communication arrangement whereby each of the at least one laser scanners associated with a respective one of the two or more piles of bulk material is connectable in communication with the computation system, the computation system being configured to:

receive from each of the at least one laser scanners by way of the communication arrangement the signal generated by each of the at least one laser scanners; and process the received signal from each of the at least one laser scanners to first remove therefrom any data that will interfere with the determination of the quantity of bulk material in the respective one of the two or more piles and then determine from each of the filtered received signal the quantity of bulk material in the respective one of the two or more piles of material and generate an output signal corresponding thereto.

### DESCRIPTION OF THE DRAWING

FIG. 1 shows is a simplified diagrammatic illustration of a system of determining a quantity of bulk material in accordance with one embodiment of the system.

FIG. 2 shows a block diagram of different modules of the system of FIG. 1.

FIG. 3 shows a method of determining a quantity of bulk material.

### DETAILED DESCRIPTION

In the following description, for purposes of explanation, numerous specific details are set forth in order to provide a thorough understanding of an embodiment of the present disclosure. It will be evident, however, to one skilled in the art that the present disclosure may be practiced without these specific details or any specific manner.

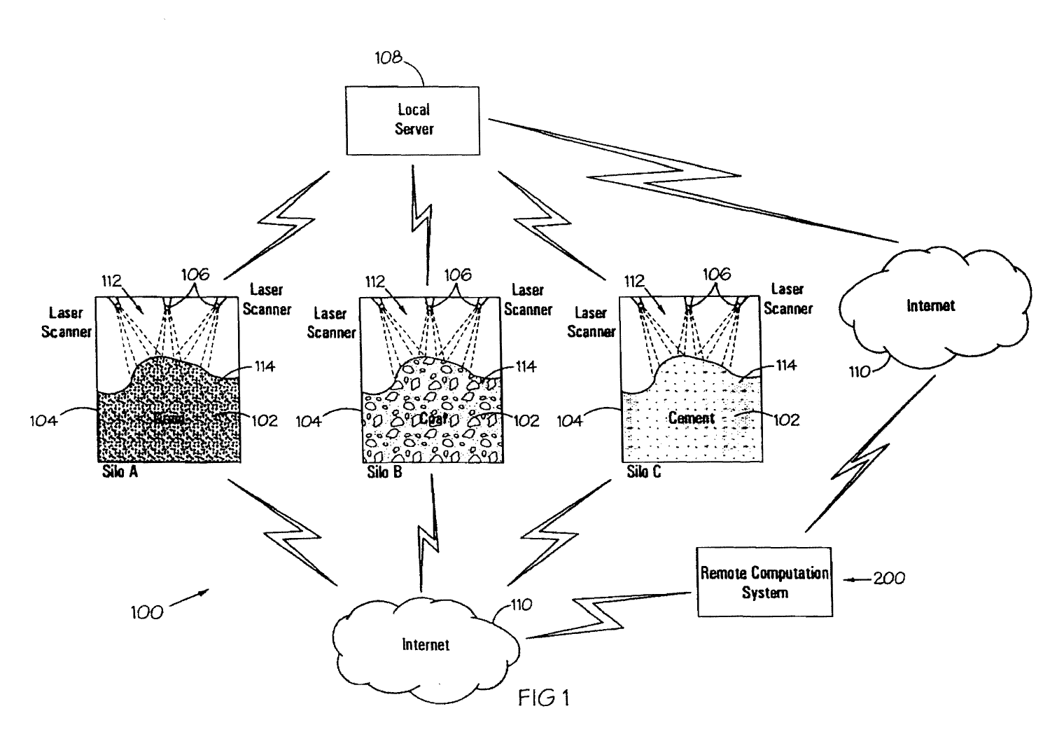

Referring to FIG. 1, a system for determining a quantity of bulk material is shown and indicated with reference numeral 100. The material 102 can be solid materials stored in a storage member 104. Alternatively, the materials can be granular materials which can also be stored in the storage member 104 such as a silo or storage bunker. Alternatively, the material 102 can be stored in a form of a stock pile. The material may be grain, coal, cement, food products, or the like. For example, silo A may be storing grain material, silo B may be storing coal and silo C may be storing cement material. Silos A, B and C are located in various locations.

The system 100 comprises multiple measuring devices 106, a remote computation system 200 and, optionally, a local server 108. The remote computation system 200 is communicatively coupled to a communications network in the form of the Internet 110. Also communicatively coupled to the Internet are the measuring devices 106 and the local server 108. Thus, the measuring devices 106 and the remote computation system 200 are networked and in communication with each other.

The measuring devices 106 are in the form of conventional laser scanners each of which includes a pulsed laser scanner and a mirror or other mechanism which directs a laser pulse from the laser scanner in order to direct the laser pulse to positions on the surface of bulk material which should be scanned accordingly. The laser scanners 106 are mounted or mountable such that there is a clear line of sight between each of the laser scanners 106 and a surface 114 of bulk material. In one example embodiment, the laser scanners 106 are permanently mounted along the periphery of the silo 104 (A, B, C). In other embodiments, the laser scanners 106 may be mounted temporarily in order to ensure an easy removal and relocation of the laser scanners 106. The laser scanners 106 can be randomly spaced apart from each other. For example, the silo 104 may define a chamber 112 and the laser scanner 106 can be mounted randomly along the periphery of the defined chamber 112 in such manner that the laser scanners are still able to have a clear visibility of the surface of bulk material 114. Put differently, a laser pulse from the laser scanner 106 should not be obstructed since the laser pulse is used to determine the quantity of bulk material (described in detail below).

Each laser scanner 106 further includes a transmit unit to transmit the laser pulse in a narrow beam towards the surface of pile of bulk of material and a receive unit to receive a reflected laser pulse.

In a preferred embodiment of the invention and as shown in FIG. 1 of the drawings, the computation system 200 will receive and process signals from a plurality of laser scanners or sets of laser scanners which are mountable to scan the surfaces of different piles of material, such as grain, coal, or cement. This illustrates that the measuring stations which includes a plurality of laser scanners are able to feed to one computation system 200 which system 200 includes one powerful processor. In particular, the powerful processor receives and processes the received signals.

The laser scanners 106 may be configured to take measurement on demand or periodically. The laser scanners 106 may take measurements on demand, in response to receiving an on demand initiation message from a remote or local source. For example, the receive unit (not shown) of the laser scanner can be further configured to receive the on demand message. Alternatively, the measurement may be taken periodically by receiving an initiation message at pre-determined intervals. The pre-determined intervals may be daily intervals, weekly intervals, and monthly intervals. It will be appreciated by those skilled in the art that the intervals may even be hourly intervals where the measurement is taken every hour. The application of the system 100 will determine best suitable intervals.

The laser scanners 106 do not have an internal memory to store measured data (signals) and/or processor unit to compute a quantity from the measured data. This will ensure that the laser scanners 106 are able to take a lot of measurements within a short period of time. Furthermore, any conventional laser scanner may be used and requires no or less modification in order to be used. Upon taking the measurements, the laser scanners automatically transmit signals (incorporating the measured data) through to the local server 108. The signals are preferably transmitted to the remote computation system 200 via the wireless network. In a preferred embodiment, the laser scanners 106 are connected to each other to form a network of laser scanners in order to ensure an easy gathering of the signals so as to transmit the signals (the measured data) to the remote computation system 200. Laser scanners associated with materials of silo A, B and C will transmit signals to the computation system 200 independent of each other. Alternatively, the laser scanners 106 may be independent from each other and transmit signals discretely to the remote computation system 200.

Each of the laser scanners 106 includes at least a motor (not shown) which enables the mirror or other mechanism to rotate, hence guide the direction of the laser pulse. Typically, the laser scanner will be positioned at a known angle in relation with the silo 104 (A, B, C). Each laser scanner 106 scans a point on the surface of the pile of bulk material. During scanning and based on the rotatable mirror or other mechanism and the location of the laser scanner 106, the laser scanner 106 will be able to scan in an upward direction, downward direction, left direction and right direction along a particular point on the surface of the pile of bulk material. Therefore, each laser scanner 106 will be able to produce many signals. The remote computation system 200 will then receive and process the signals in order to determine the quantity of bulk material in the pile. The computation system 200 will then generate an output signal corresponding to the quantity.

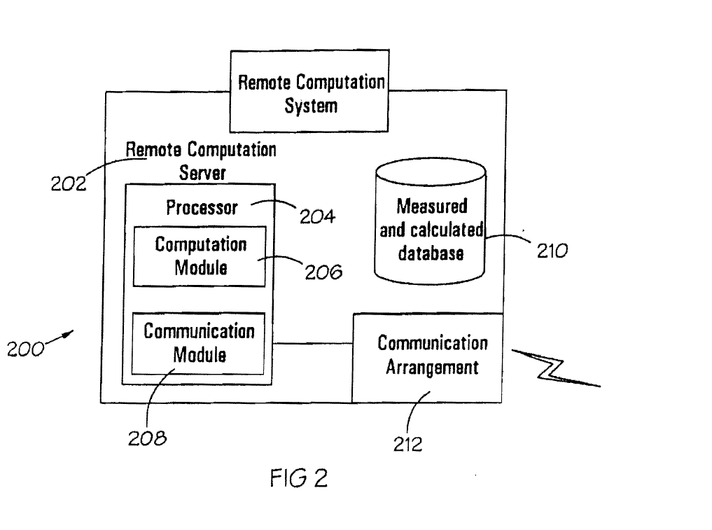

Referring now to FIG. 2, the remote computation system 200 includes a remote computation server 202 and a measured and calculated database 210. The computation server 202 includes a remote processor 204 which in turn defines a plurality of conceptual modules 206, 208 which correspond to functional tasks performed by the processor 204. The remote processor 204 includes a computation module 206 and a communication module 208. The remote processor 204 is sufficiently powerful in that it is able to receive and process signals from a plurality of measuring stations at a high speed and accurately.

The remote computation server 202 further includes a communication arrangement 212 operable to connect to a communications network in the form of the Internet 110. The measured and calculated database 210 can include signals in the form of measured data received from the laser scanners 106 or from the local server 108 and calculated data received from the computation module 206. The data stored in the database 210 is crucial in that it allows the system 200 to be traceable in that it is possible to revert back and investigate signals/measured data which were used to determine a quantity of bulk material. The measured data is processed entirely by the processor 204 so as to ensure that the data is secured and it is not vulnerable to manipulation. The measured data stored on the database 210 may even include a time stamp which will be able to provide a date and time at which a particular measurement was taken by the laser scanners 106. The calculated quantity may be any desired form, e.g. as a mass value or financial value. Preferably, it is expressed as volume. It will be appreciated that the expression of the quantity may be dependent on the application of the system 100.

To this end, the remote computation server 202 includes a computer-readable medium (not illustrated), main memory, and/or a hard disk drive, which carries a set of instructions to direct the operation of the processor 204, for example being in the form of a computer program. It is to be understood that the processor 204 may include one or more microprocessors, controllers, or any other suitable computing device, resource, hardware, software, or embedded logic. Further, the components 202 . . . 212 need not necessarily be consolidated into one device (as illustrated) and may be distributed among a number of devices networked together.

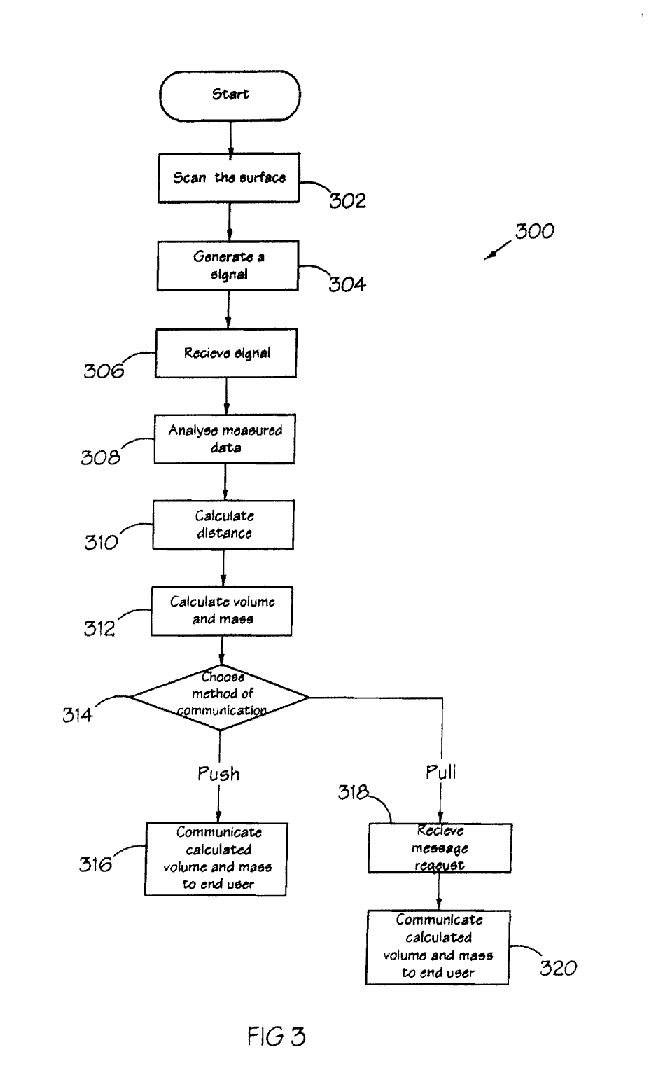

The computation module 206 and communication module 208 will be further described with reference to FIG. 3, which illustrates a method 300 of determining a quantity of bulk material in at least one pile of bulk material.

At least one laser scanner 106 scans (at block 302) the surface of bulk material. The laser scanner further generates (at block 304) a signal in response to the scanned surface.

The computation module 206 is operable to receive (at block 306) the signal (via the communication arrangement 212) generated by the laser scanner or each of the laser scanners 106. The signal is indicative of raw measured data which includes a pulse and time taken for the pulse to reflect back to a receiver unit of the laser scanner 106 or the equivalent distance thereof.

The computation module 206 analyses (at block 308) the measured data and applies a filtering mechanism to filter out any undesired data, e.g. as a result interferences which accompanied the signal. In response to applying the filtering mechanism, computation module calculates (at block 310), from the filtered measured data, a distance between the laser scanner and the surface of a pile of bulk material. Therefore, the distance may be calculated with the following formula:

D=(c×t)/2

where c is a constant indicating the speed of light t is time taken by the laser pulse to travel to the point on the surface of the pile of bulk material and to reflect back from that point to the laser scanner 106.

It will be appreciated that upon receiving the signal from the laser scanners 106, various computation techniques can be used by the processor in order to compute the quantity of bulk material. The invention illustrates one such technique which can be used to compute the quantity from the received signal.

Once the distance is calculated, there would be various distance values in relation with a square millimeter of a particular point on the surface of bulk material and respective angles of the laser scanners 106. As mentioned above, the laser scanners 106 will be positioned at known angles relative to a ground surface of the silo 104.

The distance values are further used to calculate various heights of the bulk material. The height is calculated using various conventional techniques such as triangulation technique. In this technique the following mathematical formula may be used:

H1=D×tan (θ)

where
D is distance between the laser scanner and a point on the surface of bulk material 104.

Therefore,

H=H0−H1

where
H is the height of the surface.
H0 is the known height of the laser scanner above the ground surface of the bulk of the silo.

The volume can further be calculated (at block 312) by the computation module 206, by using the following mathematical formulation:

V=sum of (H×A)

### Where:

V is the volume which represents the amount which the materials occupy in a 3D space.
H is the height of the surface
A is the area of the each point on the surface.

The computation module 206 may process data periodically by receiving an initiation message within pre-determined intervals. The pre-determined interval may include daily interval, weekly interval, monthly interval, or the like. Alternatively, the computation module may, store the received data in the database 210 and only process the data on demand.

The communication module 208 determines (at block 314) the type of communication which has been selected by an end user. The end user would have pre-selected an appropriate type of communication as he/she desires. The type of communication technique may be dependent on the application of the calculated data. For example, if the calculated data is required to be used immediately to enable the end user to use the calculated volume in a business transaction such as a sale of bulk material or whether the end user requires the volume of bulk material for record keeping so as to be able to provide the calculated data as support to any relevant stakeholder.

If the calculated data is for the abovementioned latter application, the communication module 208 communicates (at block 316) the volume of bulk material to the end user through the use of a push technology where the volume of bulk material is communicated to an end user immediately upon reception thereof. There is no initiation request received from the end user. In other embodiments, the push technology may include the use of an electronic mail where the calculated data is communicated to the end user by sending on an e-mail (enclosing the data) to the end user.

If the calculated data is used for the abovementioned former application, the communication module 208 may communicate the volume of materials through the use of a pull technology. In the pull technology, the communication module 208 receives (at block 318) an initial message request requesting the calculated volume. The communication module 208 will send (at block 320) the calculated volume to the end user. The communication module 208 which is also communicatively coupled to the database 210 and will also access the database 210 and send any other saved volumes through to the end user. The initial message request may include data and time values that the user requires a calculated volume which was calculated on a particular date and time. The end user may also request measured data which supports a particular calculated data. This illustrates the traceability of all the measured and calculated data. In other embodiments, the end user may access the system 200 through a website and log into the website to request the calculated volumes.

It should be appreciated that the method 300 and system 100, 200 for determining a volume of bulk material and provides traceable measured data in support of the determined volume. The measured data are readily available to any stakeholder who needs to verify the calculated volume.

In addition in view of the fact that the processing of data is done in a centralized processor the scanners can be relatively inexpensive and can accordingly be mounted permanently in positions.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A method of determining a quantity of bulk material in at least one pile of bulk material comprising:
scanning the surface of the pile of bulk material using one or more laser scanners;
generating a signal in response to the scanned surface;
transmitting the signal to a remote processor;
filtering said transmitted signal to remove therefrom any data that will interfere with the determination of the quantity of bulk material in the pile; and
calculating from said filtered transmitted signal the quantity of material in the pile.

2. The method of claim 1 wherein said calculating of said quantity of bulk material in the pile comprises calculating from said filtered transmitted signal a distance between said one or more laser scanners and the surface of the pile.

3. The method of claim 1 further comprising feeding the calculated quantity from the remote processor to an end user.

4. The method of claim 1 wherein said at one or more laser scanner comprises a set of scanners, each of which is positioned to have line-of-sight visibility to at least part of said pile surface and said signal generated by each of said scanners in said set are transmitted to said remote processor, the processor using the signals received from the set of scanners to calculate the quantity of material in said pile.

5. The method of claim 1 wherein said calculated quantity is expressed as a volume, a mass or a financial value.

6. A system for determining a quantity of bulk material in at least one pile of bulk material, the system comprising:
at least one laser scanner mountable or mounted such that there is a clear line of sight between the at least one laser scanner and a surface of said at least one pile of bulk material, the laser scanner being configured to generate a signal corresponding to the scanned surface;
a remote computation system; and
a communication arrangement whereby the at least one laser scanner is connectable in communication with the computation system, the computation system being configured to:
receive from the at least one laser scanner by way of the communication arrangement the signal generated by the at least one laser scanner; and
process the received signal to first remove therefrom any data that will interfere with the determination of the quantity of bulk material in the pile of material and then determine from the filtered received signal the quantity of bulk material in the pile of material and generate an output signal corresponding thereto.

7. The system of claim 6 wherein said determined quantity of bulk material in said pile is expressed as a volume, a mass or a financial value.

8. The system of claim 6 wherein said system transmits said determined quantity of bulk material to a user of said system.

9. The system of claim 6 wherein said system transmits said determined quantity of bulk material to said user in response to a request for said determined quantity.

10. The system of claim 6 wherein said at least one laser scanner is a set of laser scanners and said computation system is configured to receive signals from said set of laser scanners.

11. The system of claim 6 wherein said at least one laser scanner comprises a mechanical system that directs the position of a laser pulse from said laser scanner to a position on said bulk material pile surface which should be scanned.

12. The system of claim 9 wherein said one or more of said laser scanners in said set of laser scanners comprises a mechanical system that directs the position of a laser pulse from said one or more laser scanners to an associated position on said bulk material pile surface which should be scanned.

13. The system of claim 6 wherein said at least one laser scanner is permanently or temporarily mountable along a periphery of said bulk material pile.

14. The system of claim 13 wherein said bulk material pile is stored in a storage structure and said at least one laser scanner is permanently or temporarily mountable along a periphery of said storage structure in a manner such that a laser pulse from said at least one laser scanner can be directed to a position on said bulk material pile.

15. The system of claim 6 wherein said remote computation system includes a computation database where said signal corresponding to said scanned surface is stored therein.

16. The system of claim 6 further comprising a local server and said at least one laser scanner is in communication with said local server using said communication arrangement.

17. The system of claim 16 wherein said communication arrangement communicatively couples said local server to said remote computation system.

18. The system of claim 6 wherein said remote computation system comprises a computation server that calculates from said signal generated by the at least one laser scanner said quantity of bulk material in said pile of material.

19. A system for determining a quantity of bulk material in two or more piles of bulk material, the system comprising:
at least one laser scanner associated with a respective one of each of said two or more piles of bulk material, each of said laser scanners mountable or mounted such that there is a clear line of sight between each of the at least one laser scanners and a surface of said associated one of said two or more piles of bulk material, each of said laser scanners being configured to generate a signal corresponding to the scanned surface of each of said associated one of said two or more piles of bulk material;
a remote computation system comprising a filter; and
a communication arrangement whereby each of the at least one laser scanners associated with a respective one of said two or more piles of bulk material is connectable in communication with the computation system, the computation system being configured to:
receive from each of the at least one laser scanners by way of the communication arrangement the signal generated by each of the at least one laser scanners; and
process the received signal from each of the at least one laser scanners to first remove therefrom any data that will interfere with the determination of the quantity of bulk material in the respective one of the two or more piles and then determine from each of the filtered received signal the quantity of bulk material in the respective one of said two or more piles of material and generate an output signal corresponding thereto.
